(19) United States
(12) Patent Application Publication
(10) Pub. No.: US 2002/0155419 A1
(43) Pub. Date: Oct. 24, 2002

(54) Customizable online testing for people with disabilities

(75) Inventors: Dwip N. Banerjee, Austin, TX (US); Rabindranath Dutta, Austin, TX (US); Eduardo N. Spring, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/838,421

(22) Filed: Apr. 19, 2001

(51) Int. Cl. G09B 7/00

(52) U.S. Cl. 434/322

(57) ABSTRACT

A method, computer program product, and system for customizing an on-line test for persons with disabilities is provided. In one embodiment, a test server receives a request for a test. The test server then determines whether the user that will be taking the test has a disability and, if so, the type of disability or disabilities. The test server may also determine the type of assistive technology device, such as a text to speech converter, employed by the user in taking the test. The test server then customizes the test questions appropriately to compensate for the disability type identified by the user and presents the customized test questions to the user.

### BACKGROUND OF THE INVENTION

1. Technical Field

The present invention relates generally to computer software and, more particularly, to methods for performing testing of individuals via a networked data processing system.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Another emerging use for the Internet is the recent advent of on-line colleges and other educational institutions. Such colleges as well as traditional brick and mortar colleges are offering courses via the Internet. The educational content is offered in a variety of formats, but typically, once a course unit has been completed, the student takes a test on-line through the Internet. This allows people not located near a traditional educational institution to take courses and learn about things in a semi-formal environment that otherwise would be prohibited because of geography. It also allows people with severe demands upon their time to schedule tests and other course work at times that are convenient to them rather than at a pre-appointed time dictated by the educational institution.

However, the present method of on-line testing presents a “one-size fits all” approach to testing and does not accommodate persons with varying types of disabilities. Thus, for example, persons with vision impairment may be prevented from taking on-line tests since the on-line test are typically designed for display on a video display terminal, a method inaccessible by many people with vision impairment problems. Thus, the special needs for handicapped individuals is not currently met by the online testing industry.

Therefore, it would be desirable to have a method of customizing on-line tests to account for various disabilities of different users thereby allowing all users equal access to on-line educational coursework.

### SUMMARY OF THE INVENTION

The present invention provides a method, computer program product, and system for customizing an on-line test for persons with disabilities. In one embodiment, a test server receives a request for a test. The test server then determines whether the user that will be taking the test has a disability and, if so, the type of disability or disabilities. The test server may also determine the type of assistive technology device, such as a text to speech converter, employed by the user in taking the test. The test server then customizes the test questions appropriately to compensate for the disability type identified by the user and presents the customized test questions to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a pictorial diagram illustrating a customizable on-line testing system in accordance with the present invention;

FIG. 5 depicts an example of a table containing several versions of test questions in accordance with the present invention;

FIG. 6 depicts a pictorial diagram illustrating an exemplary form for registering disabilities of the test taker in accordance with the present invention;

FIG. 7 depicts an example of customized test that may be created and presented to a user using an assistive technology device as indicated by the user;

FIG. 8 depicts a process flow and program function for creating and presenting a customized test to a user in accordance with the present invention;

FIG. 9 depicts a block diagram of exemplary user responses and server actions in accordance with the present invention;

FIG. 10 depicts a block diagram illustrating an exemplary adjustment to test questions based on user disabilities in accordance with the present invention; and

FIG. 11 depicts a block diagram illustrating an exemplary system for adjusting question time in accordance with the present invention.

### DETAILED DESCRIPTION OF THE PREFERRED EMBODIMENT

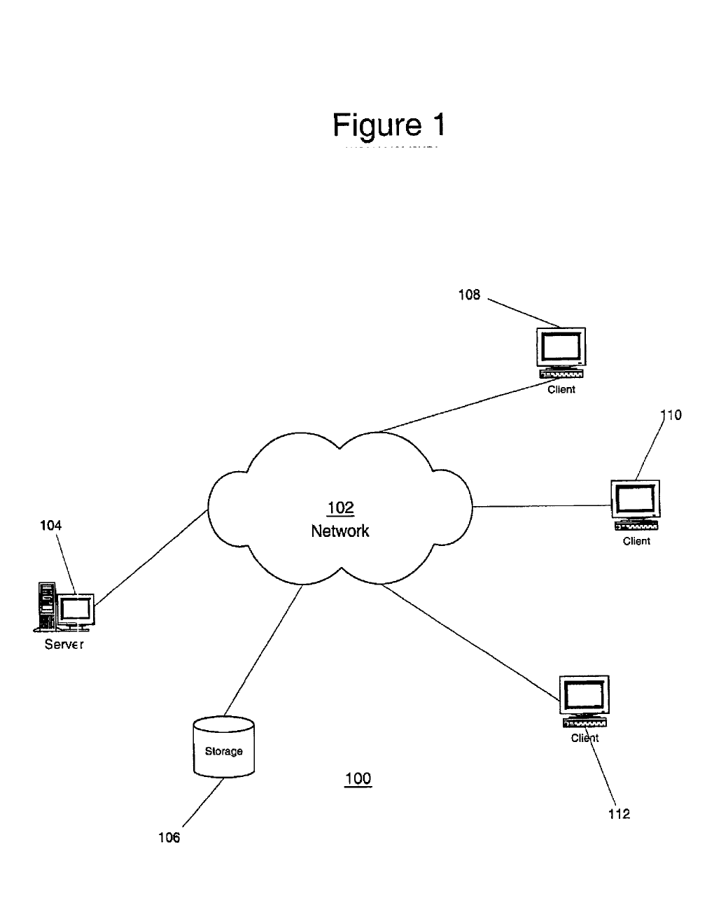

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

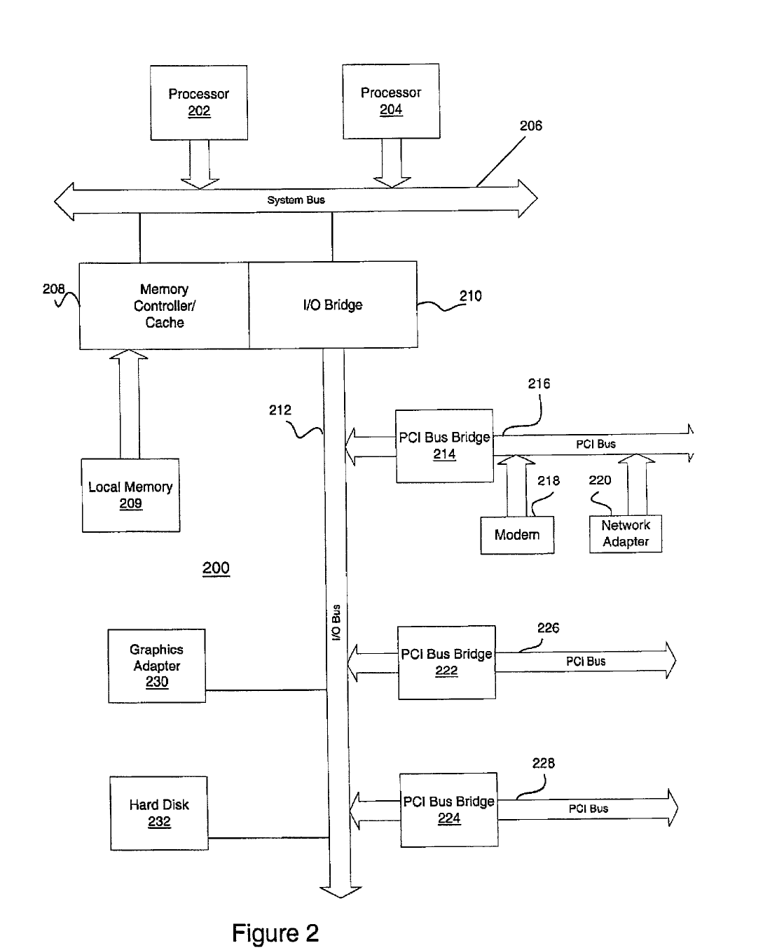

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

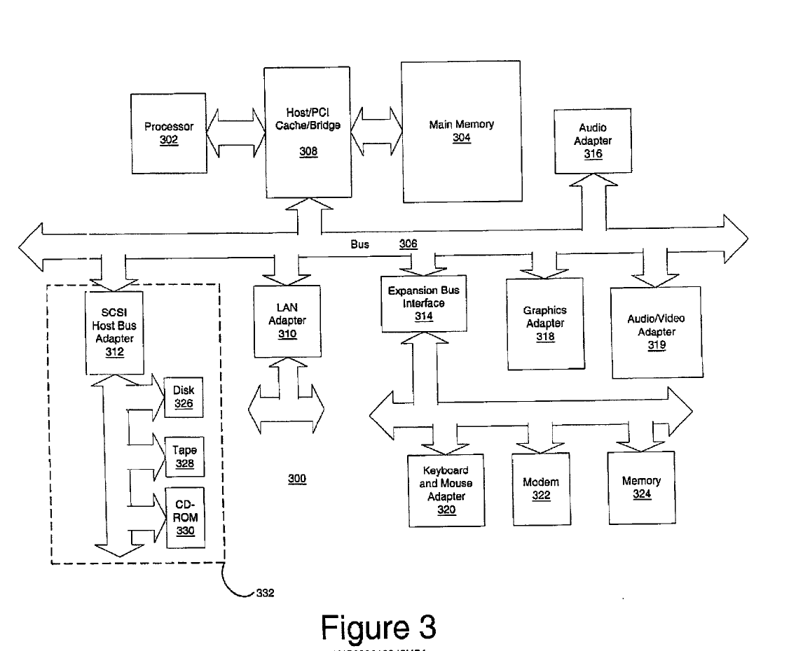

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

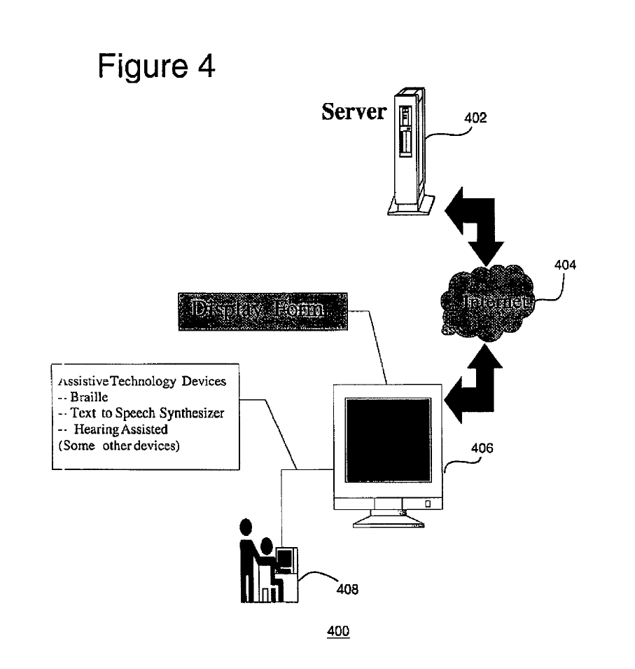

With reference now to FIG. 4, a pictorial diagram illustrating a customizable on-line testing system is depicted in accordance with the present invention. The customizable testing system 400 includes a server 402 which gathers responses from a user 408 to determine which of a plurality of versions of test questions for a given test should be provided to the user. The user 408 interacts with server 402 via terminal 406 over a network 404 such as the Internet. Server 402 may be implemented as, for example, server 104 in FIG. 1 and terminal 406 may be implemented as, for example, client 108 in FIG. 1.

The test questions for a given test may reside in a table that is stored on server 402 or on some remote storage location such as, for example, storage 106 in FIG. 1. The table of test questions may include several versions of each question with each version corresponding to a different disability on the part of the user. Thus, question 1 may have a default question version plus a version for people with vision impairments, deafness, or cognitive disabilities, such as, for example, dyslexia.

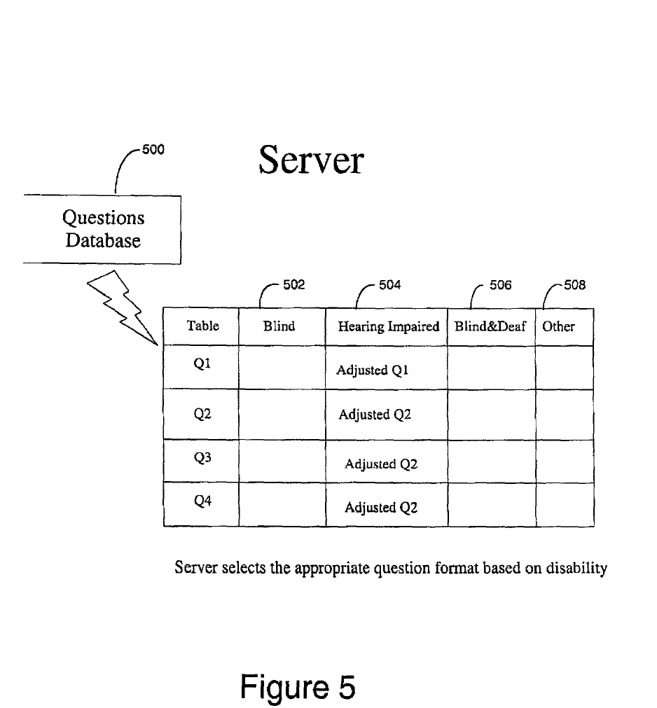

With reference now to FIG. 5, an example, of a table containing several versions of test questions is depicted in accordance with the present invention. Table 500 includes four question rows Q1-Q4. Several columns 502-508 of replacement or alternative questions are provided corresponding to various user disabilities. The server may then replace each question with the appropriate replacement question based on the disability of the user. If a replacement question is not provided for a particular question under a particular disability type, the server may use the default question as would be provided to user's not identifying any disability or may choose to omit that question as inappropriate for the particular user. Such a decision may be made by the test administrator in formatting and creating the test.

As depicted, the default questions are stored in another location and the server only accesses table 500 if the user has indicated a disability. However, in other embodiments, the default test question as well as alternative test questions may be included in the table. Furthermore, although table 500 depicts only columns for blind 502, hearing impaired 504, blind and deaf 506, and other 508, the table may include many more columns covering a much wider variety of disabilities. Thus, table 500 is provided merely as an example and not as a limitation to the present invention.

Returning now to FIG. 4, the server may send a presentation form to terminal 406 requesting that the user 408 identify what kind of disability or disabilities if any with which the user 408 is afflicted. Server 402 also may request the user 408 to identify the type of assistive technology device that the user 408 will use in taking the test.

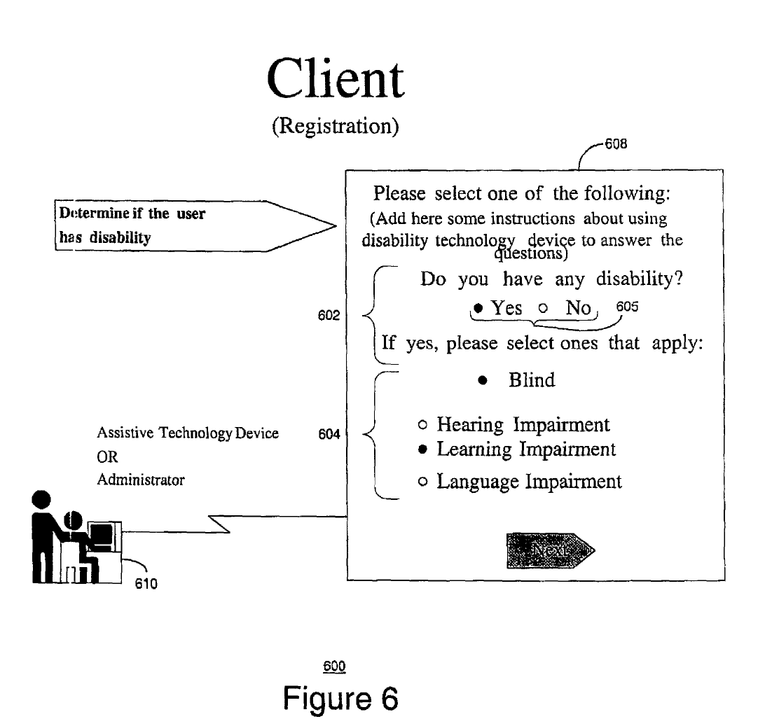

Referring now to FIG. 6, a pictorial diagram illustrating an exemplary form for registering disabilities of the test taker is depicted in accordance with the present invention. Registration system 600 includes a form 608 that may be presented to the user 610, on for example, the display of terminal 406 in FIG. 4 or through an assisted technology device such as a braille device that dynamically converts received text into braille by raising and lowering bumps on a user interface. The form 608 may include questions 602 asking the user 610 whether the user 610 has a disability and, if so, what types of disabilities. Also, although not depicted, form 608 may include questions for the user to indicate the type of assistive technology device uses.

The user may also be presented with entry areas 604-605 to indicate the answers to these questions. If the user is unable to answer these questions alone because, for example, of some physical impairment, a test proctor can answer these questions for the user. However, it is intended that typically, after the server has obtained the appropriate responses, that the test will be presented to the user in a manner in which the user can answer the questions unaided by another individual. These entries are then sent back to the server where the server uses this information to customize the test appropriately for the user 610.

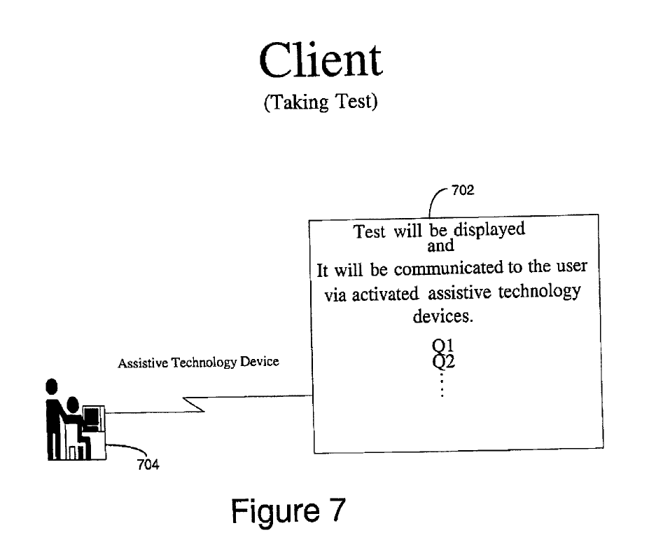

Thus, referring to FIG. 7, a customized test 702 may be created and presented to the user 704 using an assistive technology device as indicated by the user. The customized test 702 is now in a form that is more usable to the user 704 than the default test would have been. The user 704 then answers the questions and the results are sent back to the server.

Returning now to FIG. 4, the user 408 may use, for example, a braille device or a text to speech synthesizer to aid the user 408 in taking the test. Thus, if the user 408 is blind and using a braille device, the server may select an alternative version to each question that provides the test question data to the terminal 406 in a form readily interpretable by the user's braille device. In some cases, the default test question may already be in a form useable by the user's 408 assistive technology device. As another example, the test question may include a picture. However, the user 408 may be blind and using a text to speech synthesizer. The server 408 may, in such case, choose a version of the test question in which a textual description of the picture is provided. Thus, the user's 408 text to speech synthesizer could describe the picture to the user 408.

The table of test questions may also include versions of each test for people that have cognitive disabilities rather than physical disabilities. For example, large words or unusual words may be replaced by simpler language in an alternative question. Thus, the test may be presented to people with limited verbal skills. Scoring of the tests may indicate how the test has been modified for the particular individual or may actually be scaled based on the modifications to the test, thus allowing administrators to compare scores between various individuals taking different versions of the test. However, if the skills being tested are not related to the modifications, then no scaling of the scores may be necessary.

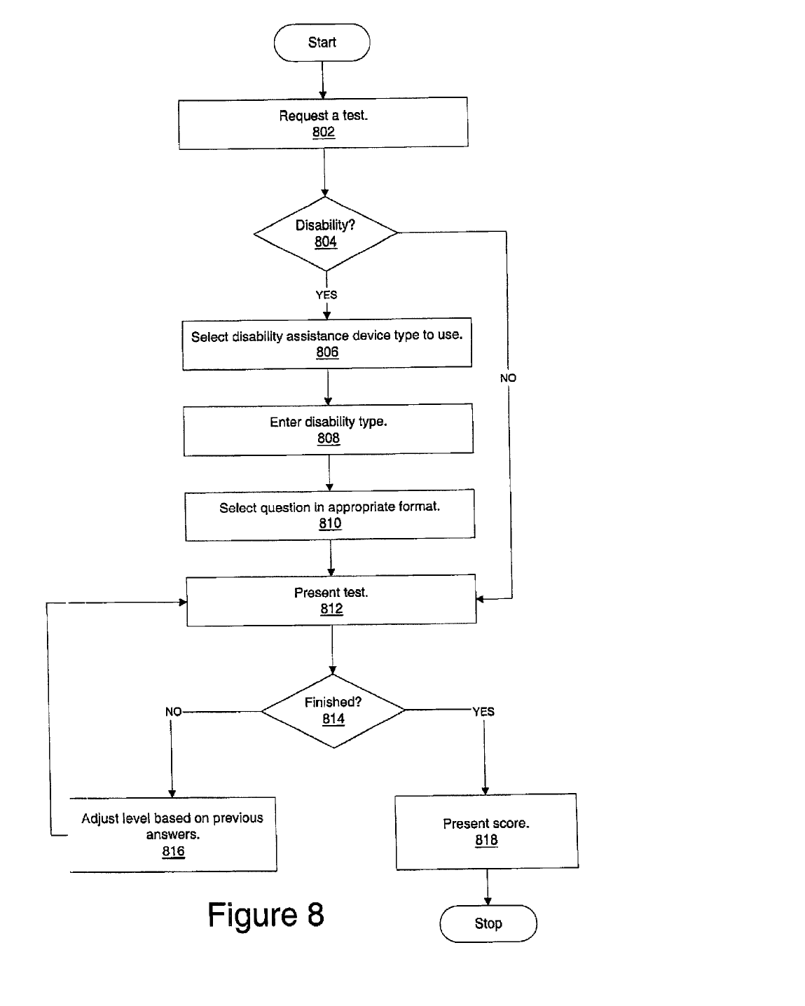

With reference now to FIG. 8, a process flow and program function for creating and presenting a customized test to a user is depicted in accordance with the present invention. To begin, a server receives a request for a test from a user (step 802). The server then determines whether the user has a disability (step 804). For example, the server may send a form or otherwise prompt the user soliciting answers to questions needed by the server in determining whether the user has a disability and, if so, what type.

If the user does not indicate a disability, then the test is presented to the user using the default questions (step 812). If the user does indicate a disability, then the server receives a selection of the disability assistance device type used by the user (step 806). The server then receives the disability type or types as entered by the user (step 808).

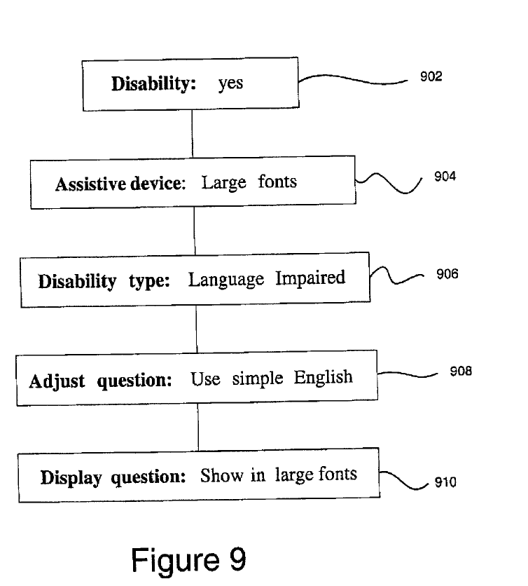

For example, referring to FIG. 9, a block diagram of exemplary user responses and server actions is depicted in accordance with the present invention. In this example, the user has indicated a disability 902 and that the assistive technology device is the need for large fonts 904. The user has also indicated that the disability type is language impairment 906. Thus, the server adjusts the questions by using simple English 908 and displays the questions using large fonts 910.

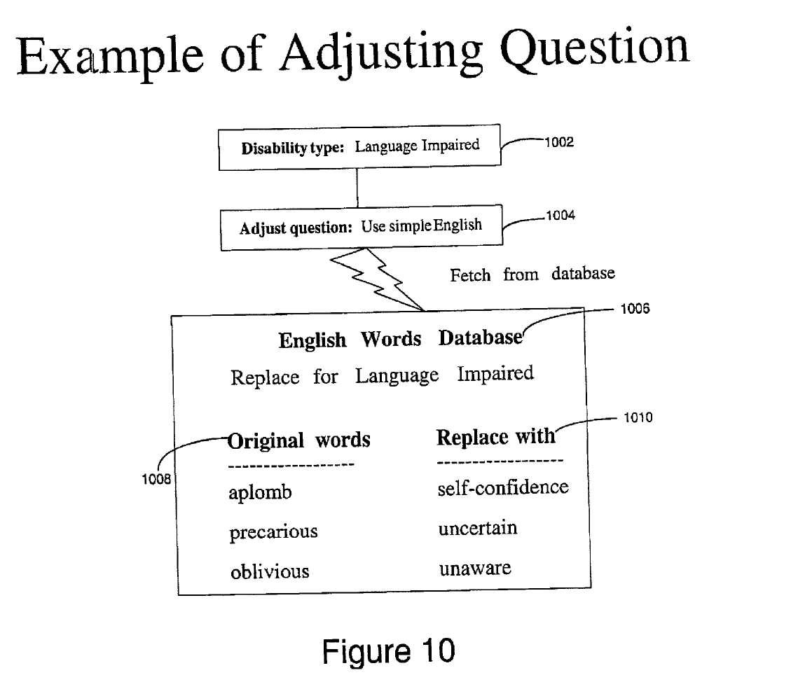

Returning again to FIG. 8, the server then, based on the user's responses to disability type and assistance device type, selects questions from a question table or database that are in an appropriate format for the user (step 810) thereby adjusting the test questions. For example, referring now to FIG. 10, a block diagram illustrating an exemplary adjustment to test questions based on user disabilities is depicted in accordance with the present invention. In this example, the user has indicated that the disability is language impairment 1002. The server adjusts the questions by using simple English 1004 and uses an English Word Database 1006 to replace original words 1008 with replacement words 1010, thus simplifying the test questions. Thus, in this example, the server does not consult a table of replacement test questions, but rather consults a word replacement table to replace words appearing in the default test questions as the occurrence warrants.

Returning now to FIG. 8, the test question or questions are then presented to the user (step 812). Once the user has answered the questions or questions, the server determines whether the test is finished (step 814). If the test is finished, then the score is calculated and presented to the user (step 818). If the test is not finished, then the server may optionally adjust question levels and types based on the previous answers (step 816) and present the next question or questions to the user (step 812). The test questions may be adjusted based on many factors. For example, the test may be a timed test, thus after the completion of a question or set of questions, the server may check the accuracy and time needed by the user in answering the questions and adjust the time accordingly.

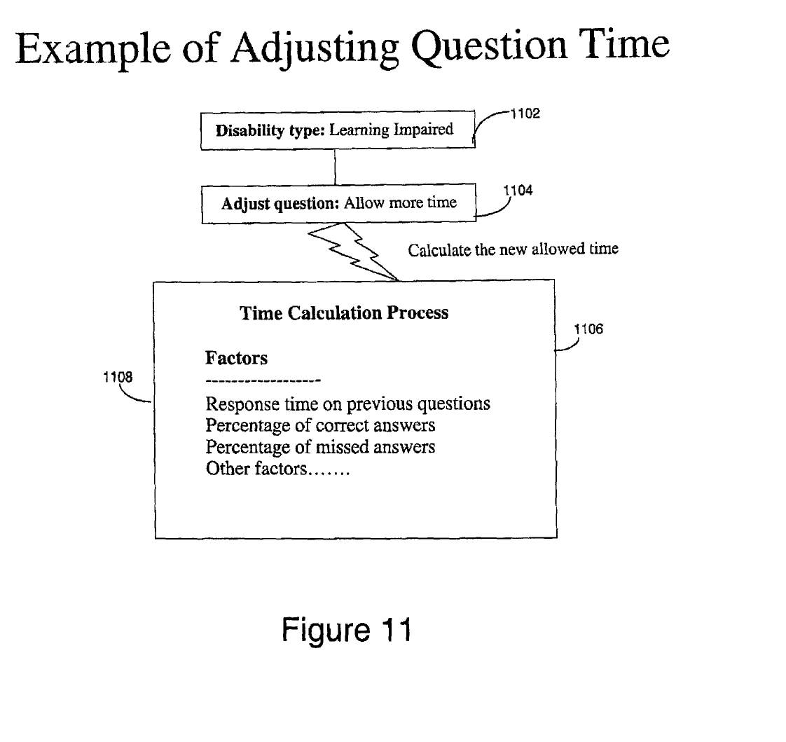

Referring now to FIG. 11, a block diagram illustrating an exemplary system for adjusting question time is depicted in accordance with the present invention. If the disability type is learning impaired 1102, the server may need to adjust the question to allow more time per question 1104. The time calculation process 1106 may include several factors 1108, such as, for example, response time on previous questions, percentage of correct answers, and percentage of missed answers as well as other factors. Thus, the server may dynamically customize the test as the test progresses to provide optimum conditions for the test taker. Such modifications may be tracked if necessary should such modifications be useful in comparing different individuals.

The present invention has been described primarily with reference to physical disabilities such as blindness and hearing impairment and cognitive disabilities such as learning impairment. However, one skilled in the art will recognize that the present invention may be applied to many more disabilities than those listed here. For example, if a user has dyslexia, and the user is taking an essay test, grading on spelling will be useless. Therefore, the testing system could be instructed to automatically correct for spelling mistakes or even use a special spelling interpreter that is programmed to detect and correct common dyslexic mistakes such as letter transposition that may not be detected by typical spell checkers. Also, for example, if English is indicated as being the user's second language, a set of questions could be presented to the user in the user's native language rather than in English.

Furthermore, the present invention is not limited to providing customized test for physical and cognitive disabilities, but may also be used to provide customized tests for persons having “technology disabilities” (i.e. having different devices available than some sort of standard device anticipated by the default test provided by the administrator). Thus, persons using a hand held device such as a PDA or wireless phone having limited display and input abilities may need a test that is customized to the technology available to the user. Also, the customized test system described herein may also be used to provide customized forms to present to persons with disabilities to perform such tasks as, for example, buying airline tickets on-line via the Internet and registering for governmental benefits on-line.

It is also important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of presenting an on-line test to a user, the method comprising:
responsive to a determination that a user has a disability and a disability type, customizing test questions appropriately to compensate for the disability type; and
sending the customized test questions to the user with the disability.

2. The method as recited in claim 1, wherein customizing test questions comprises replacing default test questions with corresponding replacement test questions based on the disability type.

3. The method as recited in claim 1, wherein customizing test questions comprises changing the appearance of the test questions presented to the user.

4. The method as recited in claim 3, wherein changing the appearance of the test questions comprises modifying the font of the test questions.

5. The method as recited in claim 4, wherein modifying the font of the test questions comprises changing font size.

6. The method as recited in claim 4, wherein modifying the font of the test questions comprises changing the font color.

7. The method as recited in claim 1, wherein customizing test questions comprises generating test questions in a format compatible with a text to braille device.

8. The method as recited in claim 1, wherein customizing test questions comprises generating test questions in a format compatible with a text to speech converter.

9. The method as recited in claim 1, wherein customizing test questions comprises implementing a special spelling interpreter to correct spelling errors to test answers responsive to a determination that the disability is dyslexia.

10. The method as recited in claim 1, further comprising:
after receiving responses to one or more customized test questions, altering customized test questions not yet presented to the user to account for factors determined by the responses to the one or more customized test questions previously presented.

11. The method as recited in claim 10, wherein altering customized test questions not yet presented to the user comprises altering the time allowed for the user to provide an answer to a test question.

12. The method as recited in claim 1, wherein the disability type is a technology disability.

13. The method as recited in claim 1, wherein the disability type is a physical disability.

14. The method as recited in claim 1, wherein the disability type is a cognitive disability.

15. A computer program product in a computer readable media for use in a data processing system for customizing an on-line test for persons with disabilities, the computer program product comprising:
first instructions, responsive to a determination that a user has a disability and a disability type, for customizing test questions appropriately to compensate for the disability type; and
second instructions for presenting the customized test questions to the user.

16. The computer program product as recited in claim 15, wherein customizing test questions comprises replacing default test questions with corresponding replacement test questions based on the disability type.

17. The computer program product as recited in claim 15, wherein customizing test questions comprises changing the appearance of the test questions presented to the user.

18. The computer program product as recited in claim 15, further comprising:
third instructions for, after receiving responses to one or more customized test questions, altering customized test questions not yet presented to the user to account for factors determined by the responses to the one or more customized test questions previously presented.

19. The computer program product as recited in claim 18, wherein altering customized test questions not yet presented to the user comprises altering the time allowed for the user to provide an answer to a test question.

20. A system for customizing an on-line test for persons with disabilities, the system comprising:
a test customizer which, responsive to a determination that a user has a disability and a disability type, customizes test questions appropriately to compensate for the disability type; and
a presentation unit which presents the customized test questions to the user.

21. The system as recited in claim 20, wherein customizing test questions comprises replacing default test questions with corresponding replacement test questions based on the disability type.

22. The system as recited in claim 20, wherein customizing test questions comprises changing the appearance of the test questions presented to the user.

23. The system as recited in claim 20, wherein customizing test questions comprises a means for generating test questions in a format compatible with a text to braille device.

24. The system as recited in claim 20, wherein customizing test questions comprises a means for generating test questions in a format compatible with a text to speech converter.

25. The system as recited in claim 20, wherein customizing test questions comprises a means for implementing a special spelling interpreter to correct spelling errors to test answers responsive to a determination that the disability is dyslexia.

26. The system as recited in claim 20, further comprising:
an adjusting unit which, after receiving responses to one or more customized test questions, alters customized test questions not yet presented to the user to account for factors determined by the responses to the one or more customized test questions previously presented.

27. The system as recited in claim 26, wherein altering customized test questions not yet presented to the user comprises a means for altering the time allowed for the user to provide an answer to a test question.

28. The system as recited in claim 20, wherein the disability type is a technology disability.

29. The system as recited in claim 20, wherein the disability type is a physical disability.

30. The system as recited in claim 20, wherein the disability type is a cognitive disability.

31. The system as recited in claim 20, wherein the disability type includes an indication of an assistive technology device utilized by the user.

32. The system as recited in claim 31, wherein the assistive technology device is a text to speech converter.

33. The system as recited in claim 31, wherein the assistive technology device is a braille device.

34. A method of receiving an on-line test, the method comprising:
receiving input indicating a user disability;
sending the input to a server;
receiving a modified question, wherein the modified question is based on the user disability; and
presenting the modified question to the user.

35. A computer program product in a computer readable media for use in a data processing system for receiving an on-line test, the computer program product comprising:
first instructions for receiving input indicating a user disability;
second instructions for sending the input to a server;
third instructions for receiving a modified question, wherein the modified question is based on the user disability; and
fourth instructions for presenting the modified question to the user.

36. A system for receiving an on-line test, the system comprising:
an input unit which receives input indicating a user disability;
a sending unit which sends the input to a server;
a question receiving unit which receives a modified question, wherein the modified question is based on the user disability; and
a presentation unit which presents the modified question to the user.
